(19) United States
(12) Patent Application Publication
(10) Pub. No.: US 2011/0138381 A1
(43) Pub. Date: Jun. 9, 2011

(54) SYSTEM AND METHOD FOR REQUESTING RESOURCES INTO A VIRTUAL MACHINE USING CONNECTION INFORMATION

(75) Inventor: Robert R. Hauser, Frisco, TX (US)

(73) Assignee: RECURSION SOFTWARE, INC., Frisco, TX (US)

(21) Appl. No.: 12/629,935

(22) Filed: Dec. 3, 2009

(51) Int. Cl. G06F 9/50; G06F 9/455

(52) U.S. Cl. 718/1; 718/104

(57) ABSTRACT

In a heterogeneous environment of virtual machines, an agent can migrate between virtual machines of different virtual machine types. During migration, objects of the serialized stream, e.g. representing a mobile agent, may need to be instantiated on the new virtual machine. Where the resources required to instantiate an object are missing on the virtual machine, the virtual machine may use connection information recorded when the serialized stream was received to connect to the source machine and request the required resources (e.g. the type for the object) from the source machine. A resource request to the source machine may specify a virtual machine type of the requesting virtual machine, thereby enabling the source machine to retrieve the correct instance of the type to return to the virtual machine.

### FIELD OF THE INVENTION

This disclosure relates to virtual machines and in particular to migrating serialized objects such as mobile agents across virtual machines of different types.

### BACKGROUND OF THE INVENTION

In heterogeneous networks where mobile agents run on advanced mobile agent platforms, a problem arises when an agent arrives at a previously unknown (unprepared) device. The problem is that an agent may not be able to operate due to the lack of availability of necessary resources at the new device. This is especially problematic for object oriented agents which typically travel networks using serialization which does not include necessary resources for the various types being used by the agent. For example, for a Java environment that receives a serialized agent, class files are needed for all of the types indicated in the serialized agent stream. These class files contain information not available in the serialized stream including the byte code implementation for the methods of the classes. In the current art these class files must be acquired outside the processing of typical serialization protocols.

To restate, agents built with object-oriented programming require the runtime environment (e.g. a virtual machine) to be able to successfully load the agent's class files (or assemblies) in order to instantiate the incoming agent. One solution is described in the context of providing a centralized resource server for various types of VMs. Specifically, in the Applicant's co-pending application Attorney Docket No. 20080815.1, the entire contents of which are explicitly incorporated herein by reference, a serialized stream contains a resource server address, such as a URL of a resource server from which the required resources can be obtained.

A disadvantage of this system is that it requires pre-configuration of a resource loader to use a resource provider and updating of the resource provider with all new resources as they are developed and deployed into an agent network. A further disadvantage of this is that it can be inefficient in requiring a new network connection to request the resource.

What is required is an alternative system and method for providing required virtual machine resources.

### SUMMARY OF THE INVENTION

In one aspect of the disclosure, there is provided a method for requesting a resource for use in a virtual machine. A serialized stream comprising one or more objects is received on a connection from the virtual machine to a source machine. The connection information is recorded and the serialized stream is deserialized. Resource requirements in respect of the one or more objects and determined which trigger a resource request to be generated. The connection information is used to provide the resource request to the source machine, which returns a resource request response.

In one aspect of the disclosure, there is provided a system comprising at least one virtual machine and at least one source machine. The source machine is configured to communicate a serialized stream to the at least one virtual machine on a connection. The virtual machine is configured to receive the serialized stream on the connection, request a resource for an object of the serialized stream on the connection, and load the resource.

In one aspect of the disclosure, there is provided a computer-readable medium comprising computer-executable instructions for execution by a processor. When executed, the instructions cause the processor to deserialize an object of a serialized stream, generate a resource request for a resource required to instantiate the object, determine a source of the serialized stream from which the serialized stream was received, establish a connection to a processor of the source, and communicate the resource request to the source processor.

### BRIEF DESCRIPTION OF THE DRAWINGS

Reference will now be made, by way of example only, to specific embodiments and to the accompanying drawings in which:

FIG. 1 shows a system including a virtual machine and a source machine;

FIG. 2 shows a method for loading resources into the virtual machine;

FIG. 3 shows a process of a deserialization module when receiving a serialized stream;

FIG. 4 shows a process of the deserialization module when receiving a resource request from a resource loader;

FIG. 5 shows an alternative system including a virtual machine and a source machine;

FIG. 6 shows a process of a resource loader of the virtual machine of FIG. 5;

FIG. 7 shows a system using a chaining process to handle heterogeneous transfers;

FIG. 8 shows a processor and memory of a virtual machine in communication with a processor of a source machine; and

FIG. 9 shows an instruction set executable on the virtual machine processor.

### DETAILED DESCRIPTION OF THE INVENTION

This disclosure describes solutions where the connection itself to the source machine is used to retrieve needed resources. This disclosure may build on or provide an optimization for the techniques described in the Applicant's co-pending patent application Attorney Docket No. 20080815.1, referenced above.

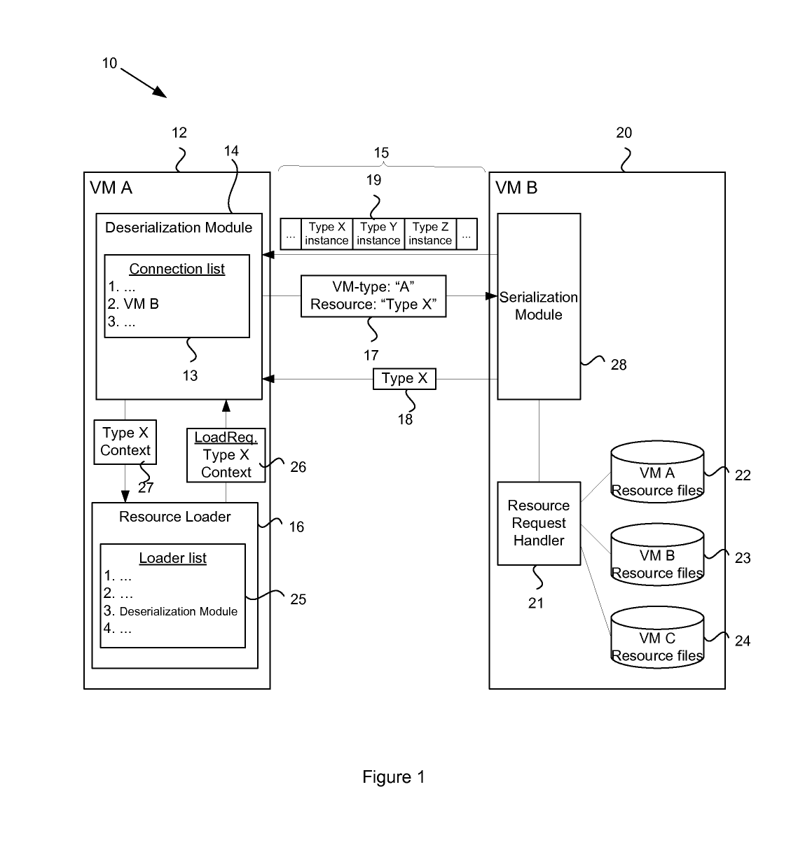

In FIG. 1, there is shown a system 10 in which a first virtual machine VM A 12 receives a serialized stream 19 from a second virtual machine VM B 20 through a network connection 15. In the general case, the first virtual machine 12 will be of a first type, type A, and the second virtual machine 20 will be of a second type, type B, though the type A and B may be the same in some instances. Different VM types operate on different bytecode such as, without limitation, Java4, Java6, .NET CLR 2.0, Android Dalvik, etc.

The network connection 15 may use any appropriate communications protocols including TCP/IP, wireless protocols, etc. The network connection 15 is logical and can be reestablished as needed based on the connection information held on both sides. E.g. a TCP connection may end (e.g. FIN, RST, timeout, etc) and be reestablished as needed at any point during processing. The reestablishment may happen on a different protocol (e.g. UDP instead of TCP). The serialized stream 19 may represent a mobile agent or similar application that is distributed on the system 10 by the second machine 20 or may have been instantiated on the second machine 20 and is moving to a new machine, i.e. the first machine 12.

The second machine 20 includes a resource request handler 21 and data storage for storing resource files for VM type A 22, VM type B 23 and VM type C 24. Data storage for other VM types may also be provided. The data storage may be amalgamated into a single data storage or may be provided in some distributed form. Machine 20 may itself run in a virtual machine of any virtual machine type. In one embodiment, one or more of the data storages 22, 23, 24 may be offsite data storage that the resource request handler 21 accesses through an appropriate network. The resource request handler 21 includes an addressing system that identifies where the resource files for different types of virtual machines can be found.

The resource files stored in the storages 22, 23, 24 may be VM-specific because they hold byte code that is VM-specific (e.g. Java class files for Java virtual machines). A resource can be a single item (e.g. a file containing a class) or a collection of items which may be an archive containing several files (e.g. a jar file, an OSGi bundle, a .NET assembly).

A communication protocol is defined for communications between the virtual machine 12 and machine 20 that specifies how resources are to be requested. Specifically, a resource request 17 from a virtual machine 12 will identify a requested resource as well as the type of the virtual machine that is making the request. The resource request handler 21 is thus able to process the resource request 17 and retrieve the requested resource from the resource file storage of the appropriate type. The resource request handler 21 responds to the resource loader with a response 18 including the requested resource. In one embodiment, communication from the virtual machine 12 to machine 20 will typically be a serialized binary stream however any suitable protocol may be used, of which HTTP, RMI, SOAP/XML, Binary XML are some examples.

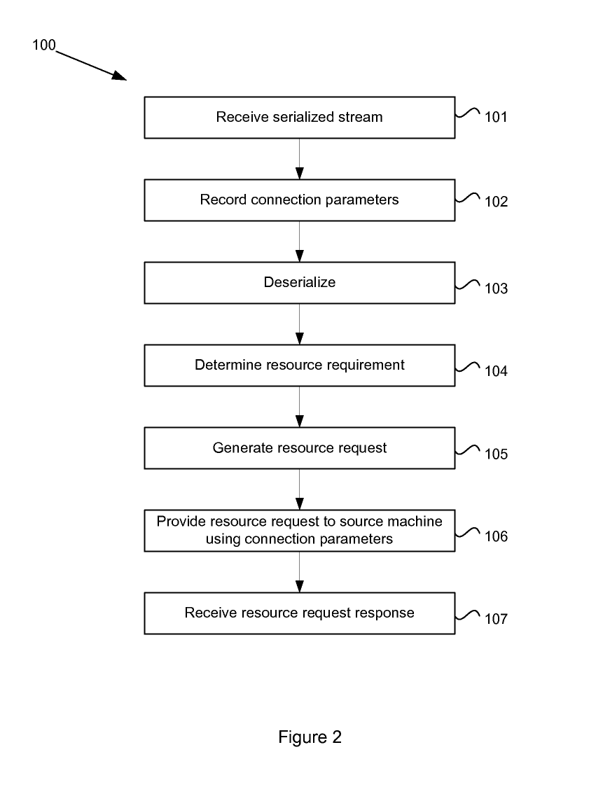

A method for loading resources into the virtual machine 12 is shown in the flowchart 100 of FIG. 2. At step 101, the virtual machine 12 receives the serialized stream 19 containing one or more objects. The serialized stream is received on the network connection 15. Machine 20 thus provides the source of the serialized stream, at least in respect of virtual machine 12, despite that the true source of the serialized stream may be some other node of a network. At step 102, VM A 12 records connection information of the connection and then proceeds to deserialize the serialized stream (step 103). If any of the objects require a resource to be loaded, as determined at step 104, a resource request is generated 105. Using the connection information of the network connection 15, the resource request 17 is provided to the source machine 20 (step 106). A resource request response is received from the source machine 20 (step 107) providing either the requested resource or an indication that the requested resource was not retrieved.

FIG. 1 shows a request for VM A resource, e.g. a Java resource, identified as Type X 17. The resource request handler 21 retrieves the requested class from the storage 22 which stores VM A (Java) classfiles and returns Type X 18 to the resource loader 16. Resources may be returned as stand alone files, archives, or in any appropriate form that can be processed by the resource loader.

VM A 12 is provided with a deserialization module 14 that receives the serialized stream from a serialization module 28 of VM B 20. The serialization/deserialization modules may be part of a mobile agent platform or other application. The deserialization module 14 deserializes and instantiates the serialized objects of the serialization stream 19 on the virtual machine 12. If additional resources are required to instantiate an object, these are requested from the resource loader 16 by providing a request 27 to the resource loader 16. The request 27 specifies a type (i.e. resource) to be loaded and a connection context of the type. The resource loader maintains a loader list 25 that specifies where resources may be obtained from. The loader list 25 may specify local loaders and network loaders. In the present embodiments, the loader list may also specify the deserialization module 14. When the resource loader 16 receives a resource request 27, the resource loader 16 will typically attempt all local loaders first. If the requested resource is unavailable from the local loaders, then the resource loader may attempt other loaders in the loader list 25. The resource loader 16 may request the resource from the deserialization module 14 in a load resource request 26. The deserialization module maintains a connection list 13, using which, the deserialization module 14 may in turn request the resource from VM B 20 on the network connection 15. The connection list 13 may store connection information learned about the connection 15 used to transfer the serialized stream 19. The connection information may include a location identity, e.g. a URL, of the second machine 20 and other relevant information such as time of connection, connection duration, etc. In one embodiment, connection information may include a connection context 27 provided to the Resource Loader 16. E.g. the connection context may have the value “2” in this example, being the index of the connection list entry for retrieving the connection location identity on which the deserialization is occurring. That is, the context is a locally-meaningful value that can be used inside the deserialization module to find the relevant location identity (i.e. look at list entry “2”) since the Deserialization Module may have many such connections and may be decoupled from resource loading. More practically, since there may be many such deserialization modules interacting with the Resource Loader, the context may contain both a module identification value (so that only the correct deserialization module will act on the request) as well as the locally-meaningful context value. In one specific example, the context passed in to the Resource Loader and received back from it in the callback could be “ModuleUID: 0x93d2fa93; LocalContext: 2”. In other embodiments, the connection information may be any information necessary to identify (and if necessary re-establish) the network connection. It may be a URL, an IP address and port number, but most practically (in a complex system) it will be a reference to another software layer that manages the connections. By storing the connection information, details of the source of the serialized stream can be retained.

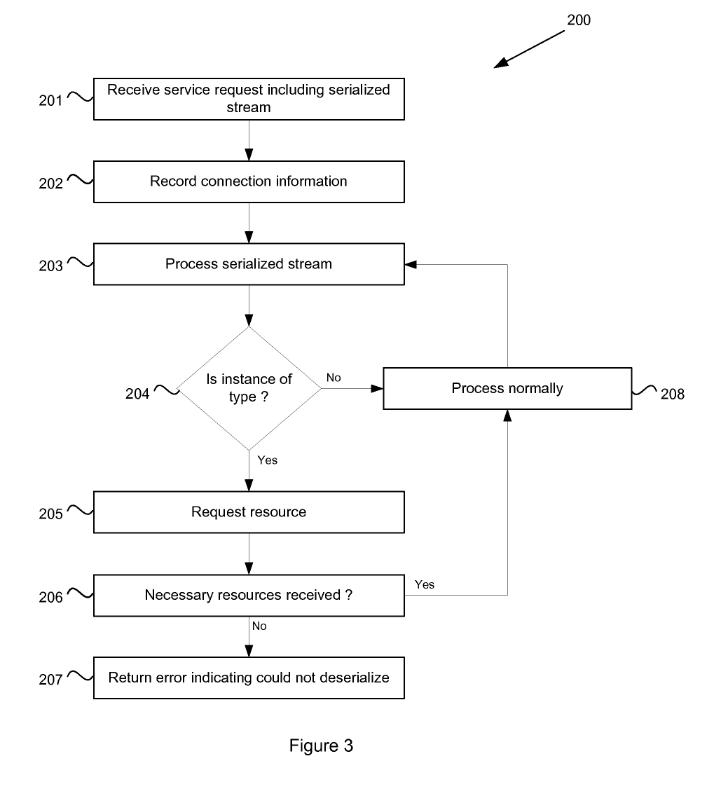

In one embodiment the network connection 15 is used to request the resource directly from the other side using the existing connection. Processing of a service request in accordance with this embodiment is described in further detail with reference to the flowchart 200 of FIG. 3. It is assumed that prior to the commencement of the process 200, the deserialization module 14 has been initialized and registered with the Resource Loader 16, and is actively awaiting service requests and/or load resource requests.

At step 201, the deserialization module 14 receives the service request including a serialized stream 19 from another machine on a particular network connection 15. The deserialization module 14 records the connection information into the connection list 13 (step 202). As described above, the connection information may include an URL, an IP address and Port number, a reference to (and context for) another module that manages connections (e.g. reconnecting as needed), or other suitable network identifier. The network connection 15 is tracked in the connection list 13, marking the connection as inactive if the connection is lost. At step 203, the serialized stream 19 is processed by selecting a first serialized item. If the serialized item is an instance of a type (i.e. a serialized object) (decision step 204), then the deserialization module 14 requests the resource for the type from the resource loader 16 (step 205). The resource request 27 specifies the type and context information (e.g. a value enabling finding the connection information detailing the connection 15 on which the serialized stream 19 was received).

In the example shown in FIG. 1, the list index “2” that can be used to find the connection identifier e.g. “VM B” is provided as a context along with the Type X resource request. More context info may be provided, e.g. a deserialization module identifier. If the resource is received in response to the request (step 206), then normal processing continues (step 208) and the type is instantiated and a next serialized item of the serialized stream can be processed (return to step 203). Otherwise, an error is returned that the serialized stream 19 could not be deserialized (step 207).

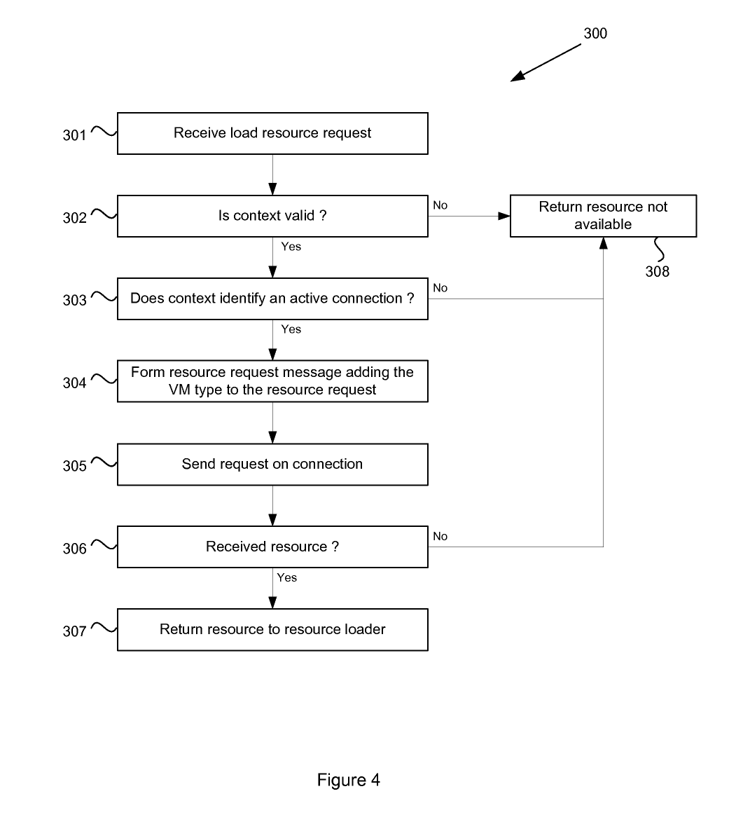

As described above, the resource loader may choose the deserialization module 14 as a source from which resources may be obtained by providing a load request 26 to the deserialization module 14. FIG. 4 shows a process 300 undertaken by the deserialization module 14 for processing the load request 26. The deserialization module 14 receives the load request 26 at step 301 and determines if the context specified in the load request 26 is valid 302. Examples where the context may not be valid include where the context includes a ModuleUID (unique module id) and this value does not match the correct value of the module receiving the request, causing the deserialization module to return an error that the requested resource is not available (step 308). If the context is valid and specifies an active connection of the deserialization module 14 (step 303), then the deserialization module 14 forms a resource request message 17 adding the VM type to the resource request (step 304) before sending the request 17 on the active connection 15 (step 305) to VM B 20. In some cases, the context's local indicator of the connection information (e.g. index “2”) may contain connection information that has been marked invalid/stale (e.g. 2. “VM B” “dead”), in which case the process proceeds to step 308. Otherwise, at the receiving machine 20, the resource request handler 21 retrieves the requested type for the specified virtual machine type and returns the type to the deserialization module 14 on the active connection 15. The deserialization module receives the type (step 306) and returns the type to the resource loader (step 307). If the requested resource is not received from the resource request handler 21 of VM B 20 before a timeout, then the deserialization module returns an error 308 that the requested resource is not available. Requested resources may be returned as stand alone files, archives, or in any appropriate form that can be processed by the resource loader.

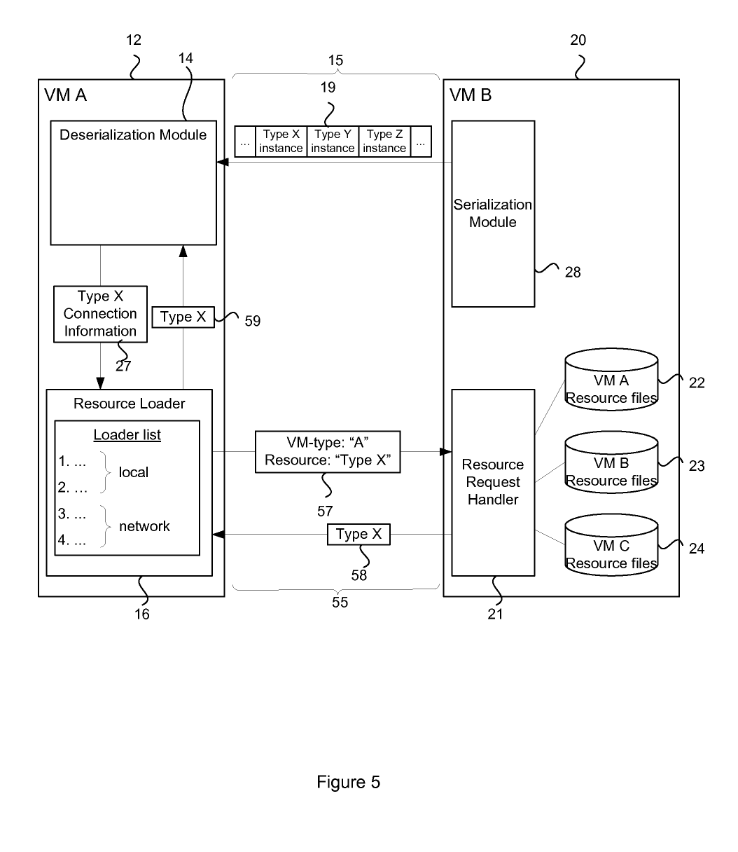

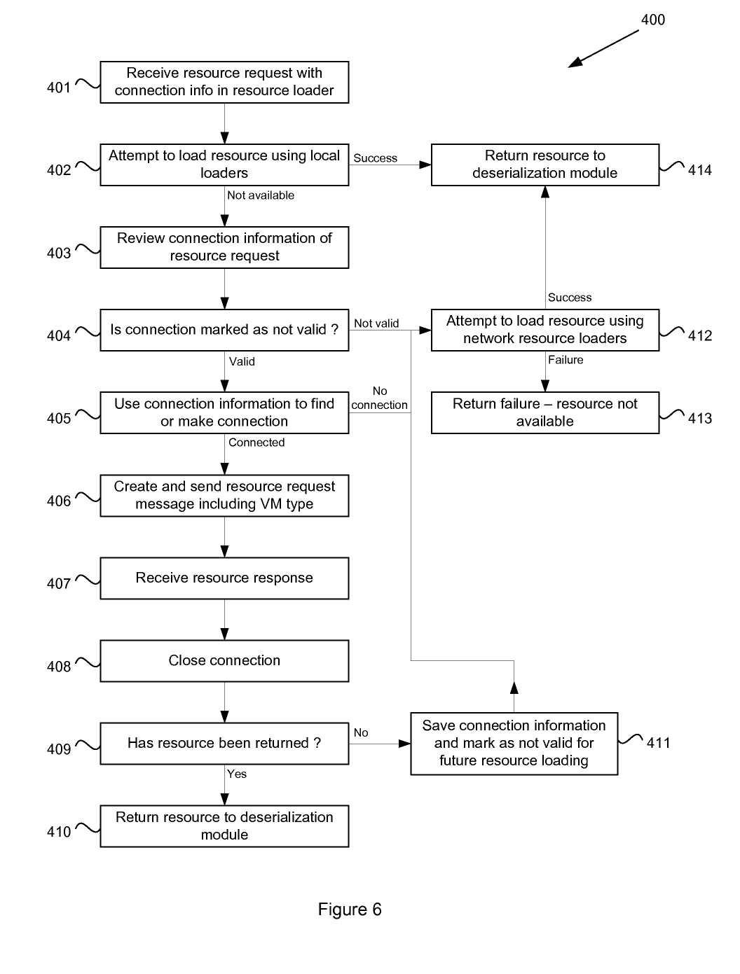

In one embodiment shown in FIG. 5, the connection information of an existing or previous connection is examined to dynamically construct a resource server URL that is used to contact the other machine 20 on a separate connection 55. This resource loader address is built on the connection information passed in with the request and not entered into the LoaderList for all resource loading, since the LoaderList of the Resource Loader must be preconfigured with possible resource loaders, local and network. In this embodiment, the service request including the serialized stream 19 may be processed the same as for the earlier embodiments as shown in FIG. 3. The deserialization module 14 provides the resource request 27 to the resource loader 16, including the connection information. A process 400 undertaken by the resource loader 16 for processing the resource request is shown in FIG. 6. The resource request 27 is received by the resource loader at step 401. Initially, the resource loader accesses the loader list and attempts to load the resource from local loaders (step 402). If local loading is successful, the resource loader 16 returns the resource to the deserialization module (step 414). If local loading is unsuccessful, the resource loader next attempts to load the resource from the source of the serialized stream. Thus the resource loader reviews the connection information of the resource request 27 (step 403). Optionally, the connection may be checked to see if it matches an entry previously cached and currently marked as not valid (step 404), in which case preconfigured network loaders may be attempted (step 412) and if unsuccessful, a resource load failure may be returned 413. However, if the connection information is not yet cached or the cached copy is indicated to be valid, the resource loader finds the existing connection or makes a new connection 55 to the machine indicated in the connection information contained in the resource request (i.e. VM B 20) (step 405). At step 406, a resource request message 57 specifying the name of the resource, “Type X”, and the VM Type is created and sent on the second connection 55. At the receiving machine 20, the resource request handler 21 retrieves the requested resource for the specified virtual machine type and returns the resource, Type X, in the resource response 58 to the resource loader 16 on the connection 55. The resource loader 16 receives the resource response (step 407), after which the connection 55 may optionally be closed (step 408) or may be closed after an inactivity timeout. If the resource has been successfully retrieved (decision step 409), then the resource loader returns the resource 59 to the deserialization module 14 (step 410). If the resource is not successfully retrieved, a copy of the connection information may be cached and marked as invalid for future resource requests (step 411). Preconfigured network loaders may then be attempted 412 and if they are unsuccessful a resource load failure may be indicated 413. While the process shown indicates that the dynamically created resource loader built from the connection information is attempted prior to other network loaders, the process may be altered so that preconfigured network loaders precede the attempt to use connection information.

While the embodiment of FIGS. 5 and 6 indicate that connection information of an active connection may be used (e.g. the connection information for network connection 15), historical or learned connection information may be provided with the resource request 27 and used to establish a resource request message 57.

From the above embodiments, it will be apparent to the skilled address that any computer connecting to another may be considered to be a resource server with active (or prior) connections being used to indicate these transient resource loaders. Considering the nature of VM specific resources required there are also two kinds of connection pairings based on the types of VMs on each side of the connection: same type of VM on each side (homogenous) and different (heterogeneous) types of VMs on each side. These issues may be considered further with reference to an end-to-end deployment of a mobile agent. A mobile agent is built with all code resources (e.g. VM type A, B, C). All resources are deployed with the mobile agent to the first VM, e.g. VM B 20 shown in FIGS. 1 and 5. The first VM has all the resources for all types of VMs that the mobile agent may move to. This first VM can act like the resource server described in the Applicant's co-pending application Attorney Docket No. 20080815.1 referenced above, as a server for any resource. The difference in the present embodiments is that no other VMs are preconfigured to know which VM is “first” with the choice being arbitrary as to which VM the mobile agent is deployed, provided that the first VM is fully equipped to operate as a resource loader for all VM types.

When the mobile agent moves to another VM, the second VM, e.g. VM A 12 of FIGS. 1 and 5, can get the needed resources from the first VM since the first VM has all types. The second VM may aggressively get all types of resources to be ready to provide them on any future connection. However, this is relatively inefficient, and so in the some cases, the second VM may only get the resources it needs. When the mobile agent moves from the second VM to a third VM, the third VM may request the resources for the mobile agent from the second VM. If the second and third VMs are of the same VM type then the resources can be provided by the second VM to the third VM. However, if the second and third VMs are of different VM types (heterogeneous) then the resources may not be available from the second VM. Thus, the third VM will need to rely on other preconfigured avenues for obtaining the required resources.

In one embodiment, the heterogeneous case may be handled by provided an indicator in the serialization stream of the mobile agent from the second VM that notifies the third VM what type the second VM is (e.g. Type B) and an indicator that the second VM has “homogenous” resources only available. In the fully general case the indicator value could have three values: any/all resources available; homogenous resources available; no resources available. This will optimize the deserialization module and resource loader to avoid unnecessary network connections. In addition, the mobile agent serialization stream may include the “Last Known Full Resource Loader URL”, as described in the Applicant's co-pending patent application Attorney Docket No. 20080815.1 referenced above. However, instead of a single URL being provided, a short list of possible URLs may be included.

As described above, an advantage of this deployment is that the mobile agent may be deployed with all resources onto an arbitrary full embodiment node, i.e. a node where the VM is also a full resource loader. More and more nodes may aggressively acquire all the resources for the mobile agent, adding their URLs to the front of the list of URLs that comes across the serialization stream. Nodes may also not acquire some resources, or only provide homogenous resources, and they may indicate such behavior in the serialization stream. However, since these nodes will still pass the URL list onto to other VMs, any future recipient can get the resources for any VM type for as long as the nodes are still active/alive.

The embodiments described herein provide an alternative to the central server model described in the Applicant's above referenced co-pending patent application Attorney Docket No. 20080815.1 by providing a distributed type of system that optimizes resource loading to try to acquire the resources needed on an existing connection (or a separate connection but back to the node that delivered the agent).

A further advantage is that a node that receives an agent can also act as a resource provider when the agent moves on. E.g. the agent arrives at the node and the node gets the resource, not just using the resources to instantiate the agent but also placing the resources in a resource repository that can be the provider of the resource when the agent moves on.

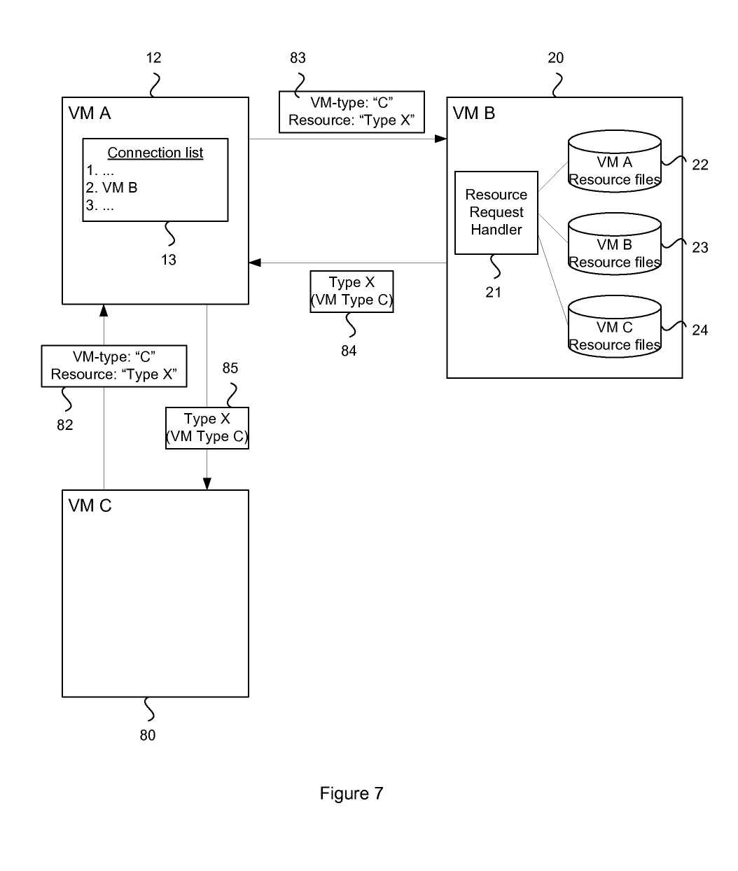

An alternative for handling the heterogeneous transfer case uses as a chaining process as shown in FIG. 7. In this example, VM B 20 is configured with resources for all VM types. VM A 12 has received a mobile agent from VM B 20 and loaded the required resources for its VM type, e.g. Type A. The mobile agent has then migrated to VM C 80 in a heterogeneous transfer, e.g. VM C 80 is a VM of Type C. However, using the methods described above, VM C may request resources 82 on the connection to VM A 12, with the request indicating the VM type of VM C 80. The requested resources on VM A 12 are not available on VM A 12 due to a type mismatch. However, instead of returning a “resource not available” indicator, VM A 12 may instead reference its own resource loader list and hence including its connection list 13, and thereby forward the resource request 83 to VM B 20 if the connection is still available. VM A 12 will thus receive the resource 84 for the VM type of VM C 80 from VM B 20 and forward this resource to VM C 80 in the resource response 85. VM A 12 may also store the request resource, enabling VM A 12 to handle any similar resource requests in the future without needing to forward the request to VM B 20. While a single chaining step is shown, a person skilled in the art will understand that any number of additional forwarding steps may be included in the chain. The chaining process may have particular application in some cases, such as in firewall/NAT/network protocol topologies and the like.

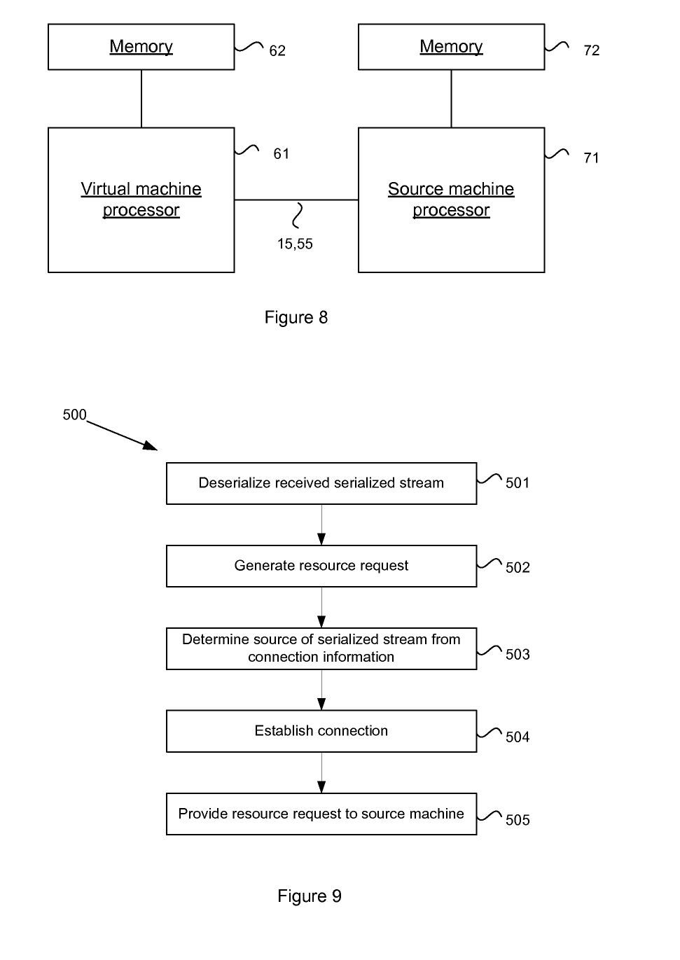

The components of the system 10 may be embodied in hardware, software, firmware or a combination of hardware, software and/or firmware. In a hardware embodiment, the virtual machine 12 may be executed on a processor 61 operatively associated with a memory 62 as shown in FIG. 8. The memory 62 may store instructions that are executable on the processor 61. In addition, the memory 62 may store aspects of the connection list 13 and loader list 25. The processor 61 may communicate with a processor 71 of the source machine which may also be operatively associated with a memory 72. An instruction set 500 that may be executed on the processor 61 is depicted in the flowchart of FIG. 9. Specifically, when executed, the instruction set 500 allows the processor 61 to deserialize an object of a serialized stream received by the processor 61 (step 501. If any of the objects of the serialized stream require resources to be instantiated on the virtual machine, the processor 61 may generate a resource request for the resource (step 502). The processor 61 determines a source of the serialized stream from which the serialized stream was received, i.e. processor 71 of the source machine 20, using connection information which may be stored in the memory 62 (step 503). Using the connection information, the processor 61 establishes the connection 15,55 to the source machine processor 71 (step 504) and communicates the resource request on the connection (step 505).

Although embodiments of the present invention have been illustrated in the accompanied drawings and described in the foregoing description, it will be understood that the invention is not limited to the embodiments disclosed, but is capable of numerous rearrangements, modifications, and substitutions without departing from the spirit of the invention as set forth and defined by the following claims. For example, the capabilities of the invention can be performed fully and/or partially by one or more of the blocks, modules, processors or memories. Also, these capabilities may be performed in the current manner or in a distributed manner and on, or via, any device able to provide and/or receive information. Further, although depicted in a particular manner, various modules or blocks may be repositioned without departing from the scope of the current invention. Still further, although depicted in a particular manner, a greater or lesser number of modules and connections can be utilized with the present invention in order to accomplish the present invention, to provide additional known features to the present invention, and/or to make the present invention more efficient. Also, the information sent between various modules can be sent between the modules via at least one of a data network, the Internet, an Internet Protocol network, a wireless source, and a wired source and via plurality of protocols.

1. A method, comprising:
receiving a serialized stream on a connection between a virtual machine and a source machine, the serialized stream comprising at least one object;
recording information associated with the connection;
determining a resource associated with the at least one object;
generating a resource request configured to request the resource; and
using the information associated with the connection to provide the resource request to the source machine.

2. The method according to claim 1, further comprising:
receiving the resource from the source machine in response to the request; and
loading the resource in the virtual machine.

3. The method according to claim 1, further comprising accessing an existing connection between the virtual machine and the source machine and providing the resource request on the existing connection.

4. The method according to claim 1, further comprising:
determining an identity of the source machine from the serialized stream.

5. The method according to claim 1, further comprising maintaining a connection list in the virtual machine that is configured to identify information associated with at least one current connection or at least one previous connections between the virtual machine and at least one source machines.

6. The method according to claim 2, wherein the resource request comprises a virtual machine type of the virtual machine.

7. (canceled)

8. The method according to claim 1, further comprising maintaining a loader list configured to identify a deserialization module of the virtual machine.

9. The method according to claim 8, further comprising:
providing the resource request from a resource loader of the virtual machine to the deserialization module, wherein the deserialization module is configured to provide the resource request to the source machine on a connection indicated by the information.

10.-11. (canceled)

12. A system, comprising:
a deserialization module configured to receive a serialized stream from a source machine on a connection between the source machine and a virtual machine, configured to record information associated with the connection, and configured to generate a request for a resource associated with an object of the serialized stream; and
a resource loader configured to determine availability of the resource on a local loader in response to the request;
wherein the deserialization module is further configured to request the resource from the source machine using the information associated with the connection in response to the resource being unavailable on the local loader.

13. The system according to claim 12, wherein the request is configured to indicate a virtual machine type of the virtual machine to the source machine.

14. The system according to claim 12, wherein the deserialization module is further configured to:
deserialize the serialized stream;
determine parameters of the connection; and
store the parameters of the connection on a connection list.

15. The system according to claim 14, wherein the resource loader is further configured to:
receive the request from the deserialization module; and
load the resource in response to the resource being available on the local loader.

16. The system according to claim 15,
wherein the resource loader is further configured to:
store a list of loaders comprising the deserialization module; and
provide a load request indicating the resource and the parameters of the connection to the deserialization module; and
wherein the deserialization module is further configured to receive the load request and to request the resource from the source machine according to the parameters of the connection.

17. The system according to claim 15, wherein the resource loader is further configured to establish a second connection to the source machine and to request the resource from the source machine on the second connection.

18. The system according to claim 17, wherein the resource loader is further configured to indicate a virtual machine type of the virtual machine to the source machine.

19. The system according to claim 12, wherein the deserialization module is further configured to:
pass the serialized stream to a second virtual machine on a second connection;
receive a second resource request for a second object of the serialized stream from the second virtual machine;
forward the second resource request to the source machine; and
forward the second resource to the second virtual machine in response to receiving the second resource from the source machine.

20. A computer-readable storage device comprising computer-executable instructions stored thereon that configure a processing device to perform operations comprising:
determining an object by deserializing a serialized stream;
generating a resource request for a resource to instantiate the object;
determining a source of the serialized stream;
establishing a connection to the source; and
communicating the resource request to the source using the connection.

21. The computer-readable storage device according to claim 20, wherein the processing device is configured to perform operations further comprising:
loading the resource in response to receiving the resource from the source.

22. The computer-readable storage device according to claim 20, wherein the processing device is configured to perform operations further comprising:
determining an identity of the source from the serialized stream.

23. The computer-readable storage device according to claim 20, wherein the processing device is configured to perform operations further comprising:
maintaining a connection list that is configured to identify information associated with at least one current connection or at least one previous connection between a virtual machine and the source.

24. The computer-readable storage device according to claim 20, wherein the processing device is configured to perform operations further comprising:
including a virtual machine type in the request.

25. A method, comprising:
transmitting a serialized stream using a connection from a source machine to a virtual machine;
receiving, from the virtual machine using the connection, a request for a resource corresponding to an object in the serialized stream, the serialized stream being configured to identify a type of the virtual machine; and
transmitting the resource to the virtual machine in response to the request.

26. The method of claim 25, further comprising storing at least one resource associated with at least one object.

27. The method of claim 25, further comprising transmitting the resource to the virtual machine using a first connection between a serialization module in the source machine and the virtual machine.

28. The method of claim 25, further comprising transmitting the resource to the virtual machine using a first connection between a resource request handler in the source machine and the virtual machine.

29. An apparatus, comprising:
a serialization module configured to transmit a serialized stream including at least one object to a virtual machine and configured to receive a request for a resource corresponding to the least one object; and
a resource request handler configured to retrieve the resource from a storage device in response to the request;
wherein the serialization module is further configured to transmit the resource to the virtual machine.

30. The apparatus of claim 29, wherein the serialization stream is further configured to include at least one parameter corresponding to a connection between the serialization module and the virtual machine.

31. The apparatus of claim 30, wherein the request is further configured to include a type of the virtual machine transmitting the request.

32. A computer-readable storage device comprising computer-executable instructions stored thereon that configure a processing device to perform operations comprising:
transmitting a serialized stream using a connection from a source machine to a virtual machine;
receiving, from the virtual machine using the connection, a request for a resource corresponding to an object in the serialized stream, the serialized stream being configured to identify a type of the virtual machine; and
transmitting the resource to the virtual machine in response to the request.

33. The computer-readable storage device according to claim 32, wherein the processing device is configured to perform operations further comprising:
storing at least one resource associated with at least one object.

34. The computer-readable storage device according to claim 32, wherein the processing device is configured to perform operations further comprising:
transmitting the resource to the virtual machine using a first connection between a serialization module in the source machine and the virtual machine.

35. The computer-readable storage device according to claim 32, wherein the processing device is configured to perform operations further comprising:
transmitting the resource to the virtual machine using a first connection between a resource request handler in the source machine and the virtual machine.
